(19) United States
(12) Patent Application Publication
(10) Pub. No.: US 2023/0027530 A1
(43) Pub. Date: Jan. 26, 2023

(54) ARTIFICIAL INTELLIGENCE (AI) ENGINE ASSISTED CREATION OF PRODUCTION DESCRIPTIONS

(71) Applicant: TrustClarity, Inc., Chicago, IL (US)

(72) Inventor: Haran Sujeevan Jeganathan, Chicago, IL (US)

(21) Appl. No.: 17/868,555

(22) Filed: Jul. 19, 2022

Related U.S. Application Data
(60) Provisional application No. 63/225,240, filed on Jul. 23, 2021.

(51) Int. Cl. G06Q 30/06; G06K 9/62; G06F 16/9535; G06F 16/9538; G06N 5/02

(52) U.S. Cl. CPC G06Q 30/0627; G06K 9/6267; G06F 16/9535; G06F 16/9538; G06Q 30/0631; G06N 5/022

(57) ABSTRACT

An artificial intelligence (AI) engine assists in the creation of product descriptions. For example, a system that includes the AI engine receives raw data including a description of a product and generates a search query based on the raw data to search the internet for possible product descriptions that satisfy the query. The system can parse the product descriptions into categories of content that map to sections of a template and creating the custom product description based on a selection and combination of the categories of content of the product descriptions matched to sections of the template. An AI-engine is trained based on the selection and combination of the categories of content and ranks the content based on a frequency of being included in custom product descriptions such that the system can later recommend content in accordance with the ranking for creating an optimal custom product.

### CROSS-REFERENCE TO RELATED APPLICATIONS

This application claims priority to U.S. Patent Application No. 63/225,240 filed Jul. 23, 2021, the content of which is hereby incorporated in its entirety.

### TECHNICAL FIELD

The disclosed teachings relate to techniques for creating custom product descriptions for electronic commerce.

### BACKGROUND

The market for global electronic components was approximately $370 billion in 2019. Large companies regularly purchase products in bulk and with long lead times. This is partially due to manufacturers requiring a large minimum order number for products and due to the time it takes for manufacturing. As such, it is not uncommon for those companies to have excess inventory of products. In certain industries, such as cable and telecommunications, companies order excess products valuing between $500,000 to $300 million. In another example, repair centers have excess purchases valued between $200,000 and $100 million per company.

Specifically, the excess ordering is caused due to complexity of the product marketplace, long lead times, high minimum order quantities, and inaccurate forecasting. In addition to the extra money spent, the excess products are often discarded at an alarming rate. For instance, 2 billion tons of e-waste are produced globally every year with only 13% being recycled and 5% composted.

The resale of excess product normally goes through brokers who manually evaluate the product to prepare a product description. In another example, the original buyers use their own product information to create descriptions for resale, which oftentimes results in incomplete or incorrect descriptions. A compelling product description provides customers with details around features, problems it solves and other benefits to help generate a sale. That is, the purpose of a product description is to supply customers with important information about the features and benefits of the product so that customers will be compelled to buy.

### BRIEF DESCRIPTION OF THE DRAWINGS

FIG. 1 is a block diagram that illustrates a system including an artificial intelligence (AI) engine that assists in the creation of product descriptions.

FIG. 2 is a flowchart that illustrates a process for AI engine-assisted creation of product descriptions.

FIG. 3 is a block diagram that illustrates an example of a processing system in which at least some operations described herein can be implemented.

The accompanying Appendix includes flowcharts and screenshots that illustrate implementations of the AI engine-assisted creation of product descriptions.

### DETAILED DESCRIPTION

The disclosed technology relates to an artificial intelligence (AI) engine for creating a custom product description based on raw product data. In one example, raw product data is pre-processed to build an expanded search query that is used to search the internet (or another corpus) for similar product descriptions. The search results are parsed into categories that define sections of a template for building the custom product description. The content in the sections is ranked and/or recommended for populating the template.

A user or system can mix-and-match content of the sections of the template. The combination and content of data used to populate the template are input as training data for the AI engine to rank/recommend in the future. The user can also directly edit the content that populates the template. The edits are further training data for the AI engine, which can learn to edit content used to populate templates in the future. The resulting custom product description can then be posted online as an offering of the product, which would be ranked higher by a search engine. Thus, the AI engine creates consumer friendly descriptions based on raw product data and improves the likelihood that other users will find the product description when searching online. Doing so can reduce inventories of excess products.

Specifically, companies regularly order products in bulk from manufacturers months in advance, based on a forecast because manufacturers require long lead times. Additionally, companies are generally forced to order in bulk because many manufacturers require a large minimum order number. As such, companies are often left with excess products. These excess products can amount to millions of dollars of loss.

To mitigate the loss, some companies rely on a resale market. Two resale markets include broker-dealers and online resale websites. Broker-dealers are third-party sales companies that routinely contact companies to offer to resell their excess products in exchange for a portion of the sale price. After an agreement is reached, the broker-dealers then find a buyer with matching interests by using similar methods and negotiate the exchange of the excess products. The buyer makes the purchase based on trusting all the parties involved. The trust can be developed based on prior interactions, the corporation involved, or proof of provenance. In one example, Comcast is selling an excess inventory of products. A buyer, due to a preexisting relationship with Comcast and trusting that a large corporation would see authenticate products, could buy the excess products due to the additional comfort and trust. Moreover, the buyer would trust the broker-dealer would perform reasonable checks to verify the authenticity of the products, based again, on prior interactions or positive history of the broker-dealer.

Another option is using online resale websites such as eBay or Amazon. On these websites, companies or broker-dealers can post a listing for the excess products. The listing can include pictures of the products, specifications of the products, the current location, and ratings of the seller. The information regarding the products can be inputted by the seller and the ratings can be based on reviews by previous customers. For example, a particular seller can have a four star review out of five stars. The online marketplace can, for example, determine the star rating based on an average of stars given by the past buyers.

This original buyer-to-reseller to resale-buyer eco-system causes many issues. First, the minimum requirements of manufacturers force companies to purchase more products than they need. For example, a corporation with a history of selling 900 widgets may still be forced to order 1,000 widgets because that is the minimum order number from the manufacturer of the widget. As a result, the company must rely on the resale market to recoup at least some of the losses. In another example, a company may forecast a need for 5,000 widgets, which could turn out to be overly optimistic when unexpected economic conditions occur. Again, the company must rely on the resale market to recoup losses.

Second, by having to order the minimum number of products, companies create unnecessary waste. Further to the example above, the company can have up to 100 excess widgets. In the resale market, an additional 80 widgets may sell. Thus, even after mitigating loss, the corporation is left with 20 excess widgets. The excess inventory is then often discarded, if not used within a reasonable amount of time due to inventory holding costs, shelf space, and accounting benefits.

Third, long lead times and large minimum order requirements push smaller companies out of the market. For example, large companies with a large credit line, large profit margins, and lengthy histories in the market, are more likely to be able to make large orders with a reasonably reliable forecast and can financially bear the risk of being wrong. On the other hand, smaller or start-up companies with small or no profit margins, and less reliable forecasting methods are less likely to be able to make such orders. Thus, these companies may struggle to find original products and may have to rely exclusively on the resale market. This causes further issues because smaller startups will struggle to be one of the first in the market because the larger companies will likely sell their excess products after the market has been saturated. Also, in contrast to larger, profitable companies, unintentional or excess inventory orders can have a material and sometime catastrophic impact to small business if not handled properly.

Fourth, the resale market can be easily exploited. Namely, resellers can sell counterfeit or inferior products to the buyer. For example, a reseller can list on an online marketplace an offer to resell a scratch resistant encasing for a cable modem box manufactured for Comcast. The reseller can specify in the listing that the box is made of scratch resistance material and the reseller may have positive reviews. Based on this information, a buyer may feel that the risk of fraud is low and place the order. However, the buyer is not presented concrete proof that the box has the qualities listed in the offer. In other words, the buyer must perform a risk analysis based on the product description that is posted to eventually get to a point where the buyer is comfortable assuming the risk. However, every aspect of the product description can be manipulated. For example, the reseller may have posted the positive reviews themselves or posted false information regarding the product. That is, the box may not be scratch proof or manufactured for Comcast; it could instead be a counterfeit box.

Oftentimes, the problem with resale sites is that product descriptions are incomplete or inaccurate. The reseller must provide images and text descriptions of a product, which is oftentimes challenging because the original seller or buyer may not have all product information available. As a result, the product descriptions are incomplete and/or erroneous. Moreover, potential buyers may forego buying products with incomplete or inadequate product descriptions or buy the wrong products.

The AI engine-enabled technology introduced here can create a custom product description based on raw product data. In one example, raw product data is pre-processed to build an expanded search query that is used to search the internet for similar product descriptions. The search results are parsed into categories that define sections of a template for building the custom product description. The content in the sections is ranked and/or recommended for populating the template. The user can then mix-and-match content of the sections of the template. The combination and content of data used to populate the template are input as training data for the AI engine to rank/recommend in the future. A user can also directly edit the content that populates the template. The edits are further training data for the AI engine, which can learn to edit content used to populate templates in the future. The resulting custom product description can then be posted online as an offering of the product, which would be ranked higher by a search engine because it is information rich. Thus, the AI engine creates consumer friendly descriptions based on raw product data and improves the likelihood that other users will find the product description when searching online.

System for AI Engine-Assisted Creation of Product Descriptions

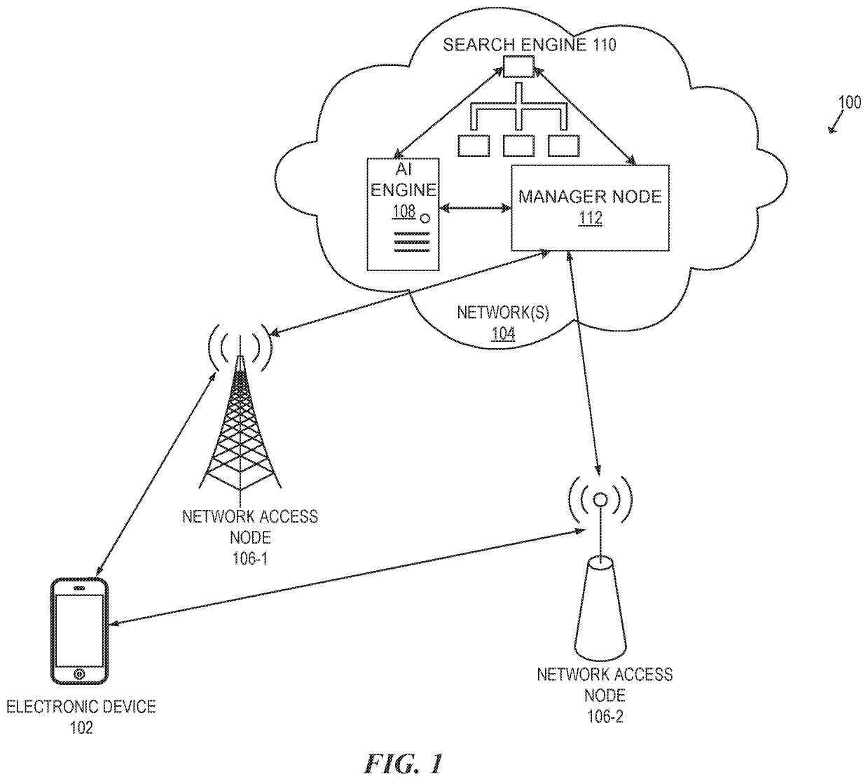

FIG. 1 is a block diagram that illustrates a system including an AI engine that assists creation of product descriptions. The system 100 includes an electronic device 102 that is communicatively coupled to one or more networks 104 via network access nodes 106-1 and 106-2 (referred to collectively as network access nodes 106). The electronic device 102 is any type of electronic device that can communicate wirelessly with a network node and/or with another electronic device in a cellular, computer, and/or mobile communications system. Examples of the electronic device 102 include smartphones (e.g., APPLE IPHONE, SAMSUNG GALAXY), tablet computers (e.g., APPLE IPAD, SAMSUNG NOTE, AMAZON FIRE, MICROSOFT SURFACE), personal computers, enterprise servers, wireless devices capable of machine-to-machine (M2M) communication, wearable electronic devices, movable Internet of Things devices (loT devices), and any other handheld device that is capable of accessing the network(s) 104. Although only one electronic device 102 is illustrated in FIG. 1, the disclosed embodiments can include any number of electronic devices.

The electronic device 102 can store and transmit (e.g., internally and/or with other electronic devices over a network) code (composed of software instructions) and data using machine-readable media, such as non-transitory machine-readable media (e.g., machine-readable storage media such as magnetic disks, optical disks, read-only memory (ROM), flash memory devices, and phase change memory) and transitory machine-readable transmission media (e.g., electrical, optical, acoustical, or other forms of propagated signals, such as carrier waves or infrared signals).

The electronic device 102 can include hardware such as one or more processors coupled to sensors and a non-transitory machine-readable media to store code and/or sensor data, user input/output (I/O) devices (e.g., a keyboard, a touchscreen, and/or a display), and network connections (e.g., an antenna) to transmit code and/or data using propagating signals. The coupling of the processor(s) and other components is typically through one or more busses and bridges (also referred to as bus controllers). Thus, a non-transitory machine-readable medium of a given electronic device typically stores instructions for execution on a processor(s) of that electronic device. One or more parts of an embodiment of the present disclosure can be implemented using different combinations of software, firmware, and/or hardware.

The network access nodes 106 can be any type of radio network node that can communicate with a wireless device (e.g., electronic device 102) and/or with another network node. The network access nodes 106 can be a network device or apparatus. Examples of network access nodes include a base station (e.g., network access node 106-1), an access point (e.g., network access node 106-2), or any other type of network node such as a network controller, radio network controller (RNC), base station controller (BSC), a relay, transmission points, and the like.

The system 100 depicts different types of wireless access nodes 106 to illustrate that the electronic device 102 can access different types of networks through different types of network access nodes. For example, a base station (e.g., the network access node 106-1) can provide access to a cellular telecommunications system of the network(s) 104. An access point (e.g., the network access node 106-2) is a transceiver that provides access to a computer system of the network(s) 104. The network(s) 104 can include any combination of private, public, wired, or wireless systems such as a cellular network, a computer network, the Internet, and the like. Any data communicated over the network(s) 104 can be encrypted or unencrypted at various locations or along different portions of the networks. Examples of wireless systems include Wideband Code Division Multiple Access (WCDMA), High Speed Packet Access (HSPA), Wi-Fi, Wireless Local Area Network (WLAN), and Global System for Mobile Communications (GSM), GSM Enhanced Data Rates for Global Evolution (EDGE) Radio Access Network (GERAN), 4G or 5G wireless wide area networks (WWAN), and other systems that can also benefit from exploiting the scope of this disclosure.

A “model,” as used herein, can refer to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, the model can be a neural network with multiple input nodes that receive input data. The input nodes can correspond to functions that receive the input and produce results. These results can be provided to one or more levels of intermediate nodes that each produce further results based on a combination of lower-level node results. A weighting factor can be applied to the output of each node before the result is passed to the next layer node. At a final layer, (“the output layer”) one or more nodes can produce a value classifying the input that, once the model is trained, can be used as to generate product data. In some implementations, such neural networks, known as deep neural networks, can have multiple layers of intermediate nodes with different configurations, can be a combination of models that receive different parts of the input and/or input from other parts of the deep neural network, or are convolutions—partially using output from previous iterations of applying the model as further input to produce results for the current input.

A machine learning model can be trained with supervised learning, where the training data includes certain data as input and a desired output. A representation of product descriptions can be provided to the model. Output from the model can be compared to the desired output for product descriptions and, based on the comparison, the model can be modified, such as by changing weights between nodes of the neural network or parameters of the functions used at each node in the neural network (e.g., applying a loss function). After applying each of the product descriptions in the training data and modifying the model in this manner, the model can be trained to evaluate new product descriptions.

The system 100 includes an AI-engine 108 that assists in the creation of product descriptions. The AI-engine 108 can include several modules (e.g., hardware and/or software) such as a machine learning (ML) module, a natural language processing (NLP) module, and a knowledge representation and reasoning module. ML algorithms build a model based on sample data, known as training data, in order to make predictions or decisions without being explicitly programmed to do so. NLP is the ability of a computer program to understand human language as it is spoken and written—referred to as natural language. The goal is a computer capable of “understanding” the contents of utterances or documents, including the contextual nuances of the language within them. The technology can then accurately extract information and insights contained therein as well as categorize and organize the inputs themselves. Related technologies include speech recognition, natural language understanding, and natural language generation.

Knowledge representation and reasoning relates to representing information about the world in a form that a computer system can utilize to solve complex tasks such as having a dialog in a natural language. Knowledge representation incorporates findings from psychology about how humans solve problems and represents knowledge in order to design formalisms that will make complex systems easier to design and build. Knowledge representation and reasoning also incorporates findings from logic to automate various kinds of reasoning, such as the application of rules or the relations of sets and subsets. Examples of knowledge representation formalisms include semantic nets, systems architecture, frames, rules, and ontologies. Examples of automated reasoning engines include inference engines, theorem provers, and classifiers. The various AI techniques and details that are well known to persons skilled in the art are omitted for the sake of brevity.

The system 100 includes a manager node 110 that can mediate the flow of data from the electronic device 102 to other components of the system 100. In some embodiments, the manager node 110 can include any number of server computers communicatively coupled to the electronic device 102 via the network access nodes 106. The manager node 110 can include combinations of hardware and/or software to process data, perform functions, communicate over the network(s) 104, etc. For example, server computers of the manager node 110 can include a processor, memory or storage, a transceiver, a display, operating system and application software, and the like. Other components, hardware, and/or software included in the system 100 that are well known to persons skilled in the art are not shown or discussed herein for brevity. Moreover, although shown as being included in the network(s) 104, the manager node 110 can be located anywhere in the system 100 to implement the disclosed technology.

The system 100 includes a search engine 110 that can process queries to identify data related to product descriptions used to populate a template for creating effective product descriptions. The search engine 110 is a software system that is designed to carry out web searches. It can search the World Wide Web in a systematic way for particular information specified in a search query. The search results can include a mix of links to web pages, images, videos, infographics, articles, research papers, datasheets, and other types of files. In one example, the search engine 110 mines data available in databases or open directories. Unlike web directories, which are maintained only by human editors, search engines also maintain real-time information by running an algorithm on a web crawler.

The manager node 112 can receive raw data from the electronic device 102. The raw data can include a description of a product. The manager node 112 can generate a search query based on the raw data and use the search engine 110 to search the internet for product description data that satisfy the query. The manager node 112 can then parse the product descriptions into categories of content that map to sections of a template and creating the custom product description based on a selection and combination of the categories of content of the product descriptions matched to the sections of the template. An AI-engine 108 is trained based on the selection and combination of the categories of content and ranks the content based on a frequency of being included in custom product descriptions such that the AI engine 108 can later recommend content in accordance with the ranking, for creating an optimal product description by using the template.

Process for AI Engine-Assisted Creation of Product Descriptions

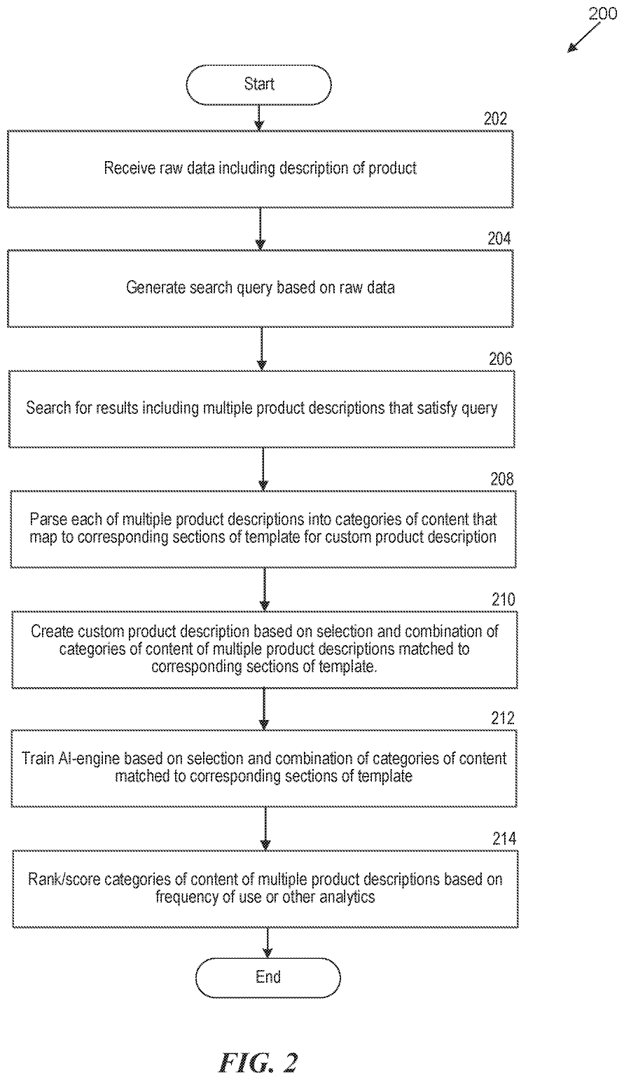

FIG. 2 is a flowchart that illustrates a process 200 for AI engine-assisted creation of product descriptions. The process can be performed by a system including a manager node, AI engine, search engine, etc. coupled to an electronic device that presents a product description.

At 202, the system receives raw data including descriptions of products. In one example, a customer sends a data file for a system that administers a platform configured to post descriptions of products on a website for resale. The data file can be a spreadsheet that lists an excess inventory including multiple products available for resale. The data file may include sparse information about the products including, for example, some product identifiers, manufacturer names, vendor identifiers, part numbers, and/or partial descriptions (e.g., provided by the original buyer/reseller/broker).

At 204, the system generates a search query by pre-processing the raw data. For example, the system can store a dictionary of keywords that are used to search the data file, sort, and organize the content of the data file to extract meaningful information. In one example, the system includes a model used to generate a probability that a product description in the data file corresponds to an identifiable product. The model can be trained using ML techniques to improve the accuracy with which it predicts the likelihood that a product is correctly identified. In one example, the model can perform NLP of the text included in the data file to look for commonalities and identify or predict a specific product based on generic or sparse data.

At 206, the system searches the internet for results including multiple product descriptions that satisfy the query. At 208, the system parses each of the multiple product descriptions into one or more categories of content that map to corresponding sections of a template for a custom product description. As such, the model can differentiate between multiple permutations of the same product to identify a specific version, etc.

At 210, the system creates the custom product description based on a selection and combination of the categories of content of the product descriptions matched to the corresponding sections of the template. In one example, the selection and combination of the categories of content of the product descriptions is based on user input.

The model (e.g., of the AI engine) can be trained based on data found online from posting of similar or the same products. For example, the system can include a search engine (or use a commercial search engine) to search for postings of similar or the same products. The search query can be based on a combination of the information extracted from data files received from clients. The search results are retrieved and stored as content for product descriptions. The content can include text, images, videos, etc. In one example, the system performs a form of scraping or utilizes a third-party service to perform the scraping for product descriptions.

The system parses each of the product descriptions retrieved from different sources into one or more categories of content that map to corresponding sections of the template for a custom product description. The categories of content can be mixed-and-matched to populate the template such that the system creates a custom product description based on the combination. The categories of content can include text, brands, logos, images, videos, pricing information, etc.

At 212, the system trains an AI-engine based on the selection and combination of the categories of content of the multiple product descriptions matched to the corresponding sections of the template. The AI-engine can alternatively or additionally be trained based on the raw data obtained from the buyer/reseller (e.g., from the data files). The input or output of the AI-engine can be in JSON format, EXCEL format, etc.

At 214, the system can rank and/or score categories of content of the product descriptions based on, for example, a frequency of being included in multiple custom product descriptions or another metric or statistic. The rank/score can reflect the likelihood that a particular category of content is a good match for a custom product description.

The AI engine is configured to recommend the categories of content of the multiple product descriptions in accordance with the ranking for populating the template for the custom product description, which can be determine algorithmically or based on predefined criteria. In one example, the AI engine includes a model that predicts the likelihood of an accurate match of content for a customized product description based on a rating score (e.g., high, medium, low). The AI engine can disambiguate data that is processed using NLP score recommendations, based on a weighted model and/or decision tree. For example, sometimes there's a match with a part number that is actually a serial number because the buyer-reseller doesn't understand, and the model can disambiguate this level of complexity.

In one example, the system can receive user input including edits to the custom product description created based on the selection and combination of the categories of content of the multiple product descriptions. For example, the model would learn if users delete portions of content and later recommend the content without the portion. The system can train the AI engine based on the edits such that the AI engine is configured to recommend the categories of content of the multiple product descriptions in accordance with the ranking and modified in accordance with the edits for populating the template for the custom product description.

The custom product descriptions are rich with content that is more likely to draw the attention of potential buyers. Moreover, the content rich product descriptions may be more highly ranked as search results because they include combinations of keywords that are more commonly included in search queries for the products. Thus, search engines will rank custom product descriptions higher than manually created product descriptions. As such, the products associated with the custom product descriptions are more likely to sell compared to the same products but with product descriptions that are manually prepared by resellers.

The accompanying Appendix includes flowcharts and screenshots that illustrate implementations of the aforementioned AI engine-assisted creation of product descriptions.

Processing System

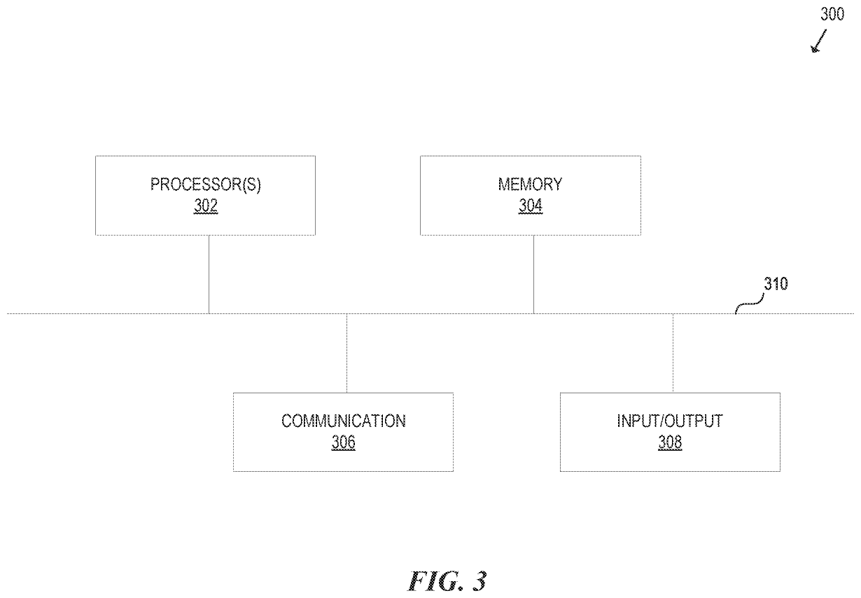

FIG. 3 is a block diagram that illustrates an example of a processing system 300 in which at least some operations described herein can be implemented. The processing system 300 represents a system that can run any of the methods/algorithms described herein. For example, any network access device (e.g., electronic device 102) or network component (access node 106-1 or manager node 112) can include or be part of a processing system 300. The processing system 300 can include one or more processing devices, which can be coupled to each other via a network or multiple networks. A network can be referred to as a communication network or telecommunications network.

In the illustrated embodiment, the processing system 300 includes one or more processors 302, memory 304, a communication device 306, and one or more input/output (I/O) devices 308, all coupled to each other through an interconnect 310. The interconnect 310 can be or include one or more conductive traces, buses, point-to-point connections, controllers, adapters and/or other conventional connection devices. Each of the processor(s) 302 can be or include, for example, one or more general-purpose programmable microprocessors or microprocessor cores, microcontrollers, application-specific integrated circuits (ASICs), programmable gate arrays, or the like, or a combination of such devices.

The processor(s) 302 control the overall operation of the processing system 300. Memory 304 can be or include one or more physical storage devices, which can be in the form of random-access memory (RAM), read-only memory (ROM) (which can be erasable and programmable), flash memory, miniature hard disk drive, or other suitable type of storage device, or a combination of such devices. Memory 304 can store data and instructions that configure the processor(s) 302 to execute operations in accordance with the techniques described above. The communication device 306 can be or include, for example, an Ethernet adapter, cable modem, Wi-Fi adapter, cellular transceiver, Bluetooth transceiver, or the like, or a combination thereof. Depending on the specific nature and purpose of the processing system 300, the I/O devices 308 can include devices such as a display (which can be a touch screen display), audio speaker, keyboard, mouse or other pointing devices, microphone, camera, etc.

While processes or blocks are presented in a given order, alternative embodiments can perform routines having steps or employ systems having blocks, in a different order, and some processes or blocks can be deleted, moved, added, subdivided, combined and/or modified to provide alternative or sub-combinations, or can be replicated (e.g., performed multiple times). Each of these processes or blocks can be implemented in a variety of different ways. In addition, while processes or blocks are at times shown as being performed in series, these processes or blocks can instead be performed in parallel or can be performed at different times. When a process or step is “based on” a value or a computation, the process or step should be interpreted as based at least on that value or that computation.

Software or firmware to implement the techniques introduced here can be stored on a machine-readable storage medium and can be executed by one or more general-purpose or special-purpose programmable microprocessors. A “machine-readable medium”, as the term is used herein, includes any mechanism that can store information in a form accessible by a machine (a machine can be, for example, a computer, network device, cellular phone, personal digital assistant (PDA), manufacturing tool, any device with one or more processors, etc.). For example, a machine-accessible medium includes recordable/non-recordable media (e.g., read-only memory (ROM), random-access memory (RAM), magnetic disk storage media, optical storage media, flash memory devices), etc.

Note that any and all of the embodiments described above can be combined with each other, except to the extent that it may be stated otherwise above, or to the extent that any such embodiments might be mutually exclusive in function and/or structure. Although the present invention has been described with reference to specific exemplary embodiments, it will be recognized that the invention is not limited to the embodiments described but can be practiced with modification and alteration within the spirit and scope of the disclosed embodiments. Accordingly, the specification and drawings are to be regarded in an illustrative sense rather than a restrictive sense.

Physical and functional components (e.g., devices, engines, modules, and data repositories) associated with processing system 300 can be implemented as circuitry, firmware, software, other executable instructions, or any combination thereof. For example, the functional components can be implemented in the form of special-purpose circuitry, in the form of one or more appropriately programmed processors, a single board chip, a field-programmable gate array, a general-purpose computing device configured by executable instructions, a virtual machine configured by executable instructions, a cloud computing environment configured by executable instructions, or any combination thereof. For example, the functional components described can be implemented as instructions on a tangible storage memory capable of being executed by a processor or other integrated circuit chip. The tangible storage memory can be computer-readable data storage. The tangible storage memory can be a volatile or non-volatile memory. In some embodiments, the volatile memory can be considered “non-transitory” in the sense that it is not a transitory signal. Memory space and storage described in the figures can be implemented with the tangible storage memory as well, including volatile or non-volatile memory.

Each of the functional components can operate individually and independently of other functional components. Some or all of the functional components can be executed on the same host device or on separate devices. The separate devices can be coupled through one or more communication channels (e.g., wireless or wired channel) to coordinate their operations. Some or all of the functional components can be combined as one component. A single functional component can be divided into sub-components, each sub-component performing separate method steps or a method step of the single component.

In some embodiments, at least some of the functional components share access to a memory space. For example, one functional component can access data accessed by or transformed by another functional component. The functional components can be considered “coupled” to one another if they share a physical connection or a virtual connection, directly or indirectly, allowing data accessed or modified by one functional component to be accessed in another functional component. In some embodiments, at least some of the functional components can be upgraded or modified remotely (e.g., by reconfiguring executable instructions that implement a portion of the functional components). Other arrays, systems, and devices described above can include additional, fewer, or different functional components for various applications.

Aspects of the disclosed embodiments may be described in terms of algorithms and symbolic representations of operations on data bits stored in memory. These algorithmic descriptions and symbolic representations generally include a sequence of operations leading to the desired result. The operations require physical manipulations of physical quantities. Usually, though not necessarily, these quantities take the form of electric or magnetic signals that are capable of being stored, transferred, combined, compared, and otherwise manipulated. Customarily, and for convenience, these signals are referred to as bits, values, elements, symbols, characters, terms, numbers, or the like. These and similar terms are associated with physical quantities and are merely convenient labels applied to these quantities.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number can also include the plural or singular number respectively. The word “or,” in reference to a list of two or more items, covers all of the following interpretations of the word: any of the items in the list, all of the items in the list, and any combination of the items in the list.

The above-detailed description of embodiments of the system is not intended to be exhaustive or to limit the system to the precise form disclosed above. While specific embodiments of, and examples for, the system are described above for illustrative purposes, various equivalent modifications are possible within the scope of the system, as those skilled in the relevant art will recognize. For example, some network elements are described herein as performing certain functions. Those functions could be performed by other elements in the same or differing networks, which could reduce the number of network elements. Alternatively, or additionally, network elements performing those functions could be replaced by two or more elements to perform portions of those functions. In addition, while processes, message/data flows, or blocks are presented in a given order, alternative embodiments may perform routines having steps, or employ systems having blocks, in a different order, and some processes or blocks may be deleted, moved, added, subdivided, combined, and/or modified to provide alternative or sub-combinations. Each of these processes, message/data flows, or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges. Those skilled in the art will also appreciate that the actual implementation of a database can take a variety of forms, and the term “database” is used herein in the generic sense to refer to any data structure that allows data to be stored and accessed, such as tables, linked lists, arrays, etc.

The teachings of the methods and system provided herein can be applied to other systems, not necessarily the system described above. The elements and acts of the various embodiments described above can be combined to provide further embodiments.

These and other changes can be made to the invention in light of the above Detailed Description. While the above description describes certain embodiments of the technology, and describes the best mode contemplated, no matter how detailed the above appears in text, the invention can be practiced in many ways. Details of the system may vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments but also all equivalent ways of practicing or implementing the invention under the claims.

While certain aspects of the technology are presented below in certain claim forms, the inventors contemplate the various aspects of the technology in any number of claim forms. For example, while only one aspect of the invention is recited as embodied in a computer-readable medium, other aspects can likewise be embodied in a computer-readable medium. Accordingly, the inventors reserve the right to add additional claims after filing the application to pursue such additional claim forms for other aspects of the technology.

1. A method for artificial intelligence (AI) engine-assisted creation of product descriptions, the method comprising:
receiving raw data including a description of a product;
generating a search query based on the raw data;
searching the internet for results including multiple product descriptions that satisfy the query;
parsing each of the multiple product descriptions into one or more categories of content that map to corresponding sections of a template for a custom product description,
creating the custom product description based on a selection and combination of the categories of content of the multiple product descriptions matched to the corresponding sections of the template;
training an AI-engine based on the selection and combination of the categories of content of the multiple product descriptions matched to the corresponding sections of the template; and
ranking the categories of content of the multiple product descriptions based on a frequency of being included in multiple custom product descriptions,
wherein the AI engine is configured to recommend the categories of content of the multiple product descriptions in accordance with the ranking for populating the template for the custom product description.

2. The method of claim 1, wherein the selection and combination of the categories of content of the multiple product descriptions is based on user input.

3. The method of claim 1 further comprising:
receiving user input including edits to the custom product description; and
train the AI engine based on the edits such that the AI engine is configured to recommend the categories of content of the multiple product descriptions in accordance with the ranking and modified in accordance with the edits.
